(19) United States
(12) Patent Application Publication
(10) Pub. No.: US 2026/0167218 A1
(43) Pub. Date: Jun. 18, 2026

(54) AUTONOMOUS VEHICLE CONTORL IN UNMARKED LANE INTERSECTION

(71) Applicant: GM GLOBAL TECHNOLOGY OPERATIONS LLC, Detroit, MI (US)

(72) Inventors: Guangyu Jeff Zou, Warren, MI (US); Han Ul Lee, Stering Heights, MI (US)

(21) Appl. No.: 18/978,539

(22) Filed: Dec. 12, 2024

(51) Int. Cl. B60W 60/00; B60W 10/04; B60W 10/18; B60W 10/20; G01C 21/36; G06V 20/13; G06V 20/54; G06V 20/56

(52) U.S. Cl. CPC B60W 60/001; B60W 10/04; B60W 10/18; B60W 10/20; G01C 21/3602; G01C 21/3658; G06V 20/13; G06V 20/54; G06V 20/588; B60W 2420/403; B60W 2556/50; B60W 2710/18; B60W 2710/20; B60W 2720/106

(57) ABSTRACT

An example vehicle autonomous driving control system includes a satellite configured to obtain aerial images of an intersection including an unmarked lane, an infrastructure mounted camera configured to obtain images of the intersection, a front vehicle camera, a vehicle wireless interface configured to wirelessly receive the aerial images and the one or more infrastructure camera images, and a vehicle control module configured to access the aerial images and the infrastructure camera images, obtain vehicle camera images from the front vehicle camera, supply the aerial images, the infrastructure camera images, and the vehicle camera images, to at least one machine learning model to generate a virtual lane prediction indicative of one or more unmarked lanes present in the intersection, and automatically control steering, acceleration and braking of the vehicle in the intersection according to the virtual lane prediction.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure generally relates to autonomous vehicle control in unmarked lane intersections, including predicting virtual lane locations based on aerial imagery, infrastructure-mounted cameras and vehicle cameras.

Autonomous vehicles may use vehicle cameras to detect lane markings on road surfaces for automated steering control. Intersection scenarios may be challenging for autonomous vehicles to navigate, where lane markings are absent from the intersection.

### SUMMARY

An example vehicle autonomous driving control system includes at least one satellite configured to obtain one or more aerial images of an intersection, wherein the intersection includes at least one unmarked lane, an infrastructure mounted camera configured to obtain one or more infrastructure camera images of the intersection, wherein the infrastructure mounted camera is oriented with a viewing angle in a direction of the intersection, a front vehicle camera configured to capture images from a front field of view of a vehicle, a wireless interface of the vehicle, wherein the wireless interface is configured to wirelessly receive the one or more aerial images and the one or more infrastructure camera images, and a vehicle control module configured to access the one or more aerial images and the one or more infrastructure camera images, obtain one or more vehicle camera images from the front vehicle camera, supply the one or more aerial images, the one or more infrastructure camera images, and the one or more vehicle camera images, to at least one machine learning model, generate a virtual lane prediction according to an output of the at least one machine learning model, the virtual lane prediction indicative of one or more unmarked lanes present in the intersection, and automatically control steering, acceleration and braking of the vehicle in the intersection according to the virtual lane prediction.

In some examples, supplying the one or more aerial images includes supplying the one or more aerial images to a transformer encoder machine learning model. In some examples, supplying includes supplying the one or more infrastructure camera images and the one or more vehicle camera images to a bird's eye view (BEV) encoder machine learning model.

In some examples, the vehicle control module is configured to supply an output of the transformer encoder machine learning model as an input to a map decoder machine learning model, supply map query data and map loss data as inputs to the map decoder machine learning model, and generate the virtual lane prediction at least in part based on an output of the map decoder machine learning model.

In some examples, the vehicle control module is configured to supply an output of the transformer encoder machine learning model as an input to an auxiliary actor decoder machine learning model, supply actor query data and actor loss data as inputs to the auxiliary actor decoder machine learning mode, and generate the virtual lane prediction at least in part based on an output of the auxiliary actor decoder machine learning model.

In some examples, the vehicle control module is configured to concatenate a subset of actor features of the auxiliary actor decoder machine learning model to a list of map feature inputs of the map decoder machine learning model. In some examples, the vehicle control module is configured to supply the one or more aerial images to a convolutional neural network, and supply an output of the convolutional neural network to a transformer encoder machine learning model.

In some examples, automatically controlling steering, acceleration and braking of the vehicle includes controlling operation of the vehicle via map-free autonomous driving.

In some examples, the vehicle control module is configured to obtain the one or more vehicle camera images from the front vehicle camera in real-time in response to the vehicle approaching the intersection, and access the one or more aerial images and the one or more infrastructure camera images from a stored memory, wherein the access the one or more aerial images and the one or more infrastructure camera images are previously stored images.

In some examples, the vehicle control module is configured to determine an intersection over union (IoU) loss for bounding boxes of predicted lanes and ground truth labels, for the map decoder machine learning model. In some examples, the vehicle control module is configured to determine a cosine of an angle between principal orientations of predicted actor orientations and ground truth orientation labels, for the auxiliary actor decoder machine learning model.

An example method of vehicle autonomous driving control includes obtaining, via a wireless interface of a vehicle, one or more aerial images of an intersection, wherein the intersection includes at least one unmarked lane, and the one or more aerial images are captured by at least one satellite, obtaining, via the wireless interface of the vehicle, one or more infrastructure camera images of the intersection from an infrastructure mounted camera, wherein the infrastructure mounted camera is oriented with a viewing angle in a direction of the intersection, receiving one or more vehicle camera images from a front vehicle camera of the vehicle, supplying the one or more aerial images, the one or more infrastructure camera images, and the one or more vehicle camera images, to at least one machine learning model, generating a virtual lane prediction according to an output of the at least one machine learning model, the virtual lane prediction indicative of one or more unmarked lanes present in the intersection, and automatically controlling steering, acceleration and braking of the vehicle in the intersection according to the virtual lane prediction.

In some examples, supplying the one or more aerial images includes supplying the one or more aerial images to a transformer encoder machine learning model. In some examples, supplying includes supplying the one or more infrastructure camera images and the one or more vehicle camera images to a bird's eye view (BEV) encoder machine learning model.

In some examples, the method includes supplying an output of the transformer encoder machine learning model as an input to a map decoder machine learning model, supplying map query data and map loss data as inputs to the map decoder machine learning model, and generating the virtual lane prediction at least in part based on an output of the map decoder machine learning model.

In some examples, the method includes supplying an output of the transformer encoder machine learning model as an input to an auxiliary actor decoder machine learning model, supplying actor query data and actor loss data as inputs to the auxiliary actor decoder machine learning model, and generating the virtual lane prediction at least in part based on an output of the auxiliary actor decoder machine learning model.

In some examples, the method includes concatenating a subset of actor features of the auxiliary actor decoder machine learning model to a list of map feature inputs of the map decoder machine learning model. In some examples, the method includes supplying the one or more aerial images to a convolutional neural network, and supplying an output of the convolutional neural network to a transformer encoder machine learning model.

In some examples, the method includes automatically controlling steering, acceleration and braking of the vehicle includes controlling operation of the vehicle via map-free autonomous driving.

An example vehicle autonomous driving control system includes a front vehicle camera configured to capture images from a front field of view of a vehicle, a wireless interface configured to wirelessly receive one or more aerial images of an intersection, wherein the intersection includes at least one unmarked lane, and the one or more aerial images are captured by at least one satellite, and wireless receive one or more infrastructure camera images of the intersection from an infrastructure mounted camera, wherein the infrastructure mounted camera is oriented with a viewing angle in a direction of the intersection, and a vehicle control module configured to access the one or more aerial images and the one or more infrastructure camera images, obtain one or more vehicle camera images from the front vehicle camera, supply the one or more aerial images, the one or more infrastructure camera images, and the one or more vehicle camera images, to at least one machine learning model, generate a virtual lane prediction according to an output of the at least one machine learning model, the virtual lane prediction indicative of one or more unmarked lanes present in the intersection, and automatically control steering, acceleration and braking of the vehicle in the intersection according to the virtual lane prediction.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a diagram of an example vehicle including a vehicle control module configured to determine virtual lanes at unmarked intersections.

FIG. 2 is an example overhead view of a road intersection with unmarked lanes.

FIG. 3 is a block diagram of an example system for predicting virtual lanes in an intersection using aerial images and a transformer encoder.

FIG. 4 is a block diagram of an example system for predicting virtual lanes in an intersection using infrastructure camera images and vehicle camera images, using a bird's-eye view former encoder.

FIG. 5 is a flowchart depicting an example process for predicting virtual lanes in an intersection using aerial images and a transformer encoder.

FIG. 6 is a flowchart depicting an example process for predicting virtual lanes in an intersection using infrastructure camera images and vehicle camera images, using a bird's-eye view former encoder.

FIG. 7 is a flowchart depicting an example process for modifying inputs map input features of a map decoder based on corresponding actor features.

FIG. 8 is a flowchart depicting an example process of determining virtual lanes at unmarked intersections.

FIGS. 9A and 9B are graphical representations of example recurrent neural networks for predicting virtual lanes at unmarked intersections.

FIG. 10 is a graphical representation of layers of an example long short-term memory (LSTM) machine learning model.

FIG. 11 is a flowchart illustrating an example process for training a machine learning model.

In the drawings, reference numbers may be reused to identify similar and/or identical elements.

### DETAILED DESCRIPTION

Autonomous vehicles may use vehicle cameras to detect lane markings on road surfaces for automated steering control. Intersection scenarios may be challenging for autonomous vehicles to navigate, where lane markings are absent from the intersection, particularly for high definition mapping processes and high definition map-free autonomous driving. In some example embodiments herein, geometric and topologic structures of lanes in an intersection are inferred via higher-level scene understanding of a vehicle control module.

For example, a unified learning-based method may be implemented to infer regular lanes and road features (e.g., crosswalks), and virtual lanes at intersections. A vehicle control module may determine virtual lanes using one or more trained machine learning models receiving inputs of aerial imagery of an intersection, vehicle camera images, and infrastructure-based cameras (e.g., cameras mounted on streetlights, buildings, etc. around an intersection).

In some examples, the system may be configured to virtual lanes based on other implicit cues in the scene. For example, a unified and versatile decoder design may receive for lane instance detection based on aerial-based images, vehicle camera-based images, and/or infrastructure camera-based images. A detailed transformer-based, multi-head decoder design may maximally exploit implicit scene knowledge for detailed vectorized lane instance detection on-the-fly, which may include lane types, lane edge types, centerlines, lane edge offsets, etc., as a holistic lane representation.

In some examples, a specific attention mechanism may implicitly integrate relevant information of actor orientation into lane instance detection. Specific matching criteria may be used to associate prediction results with ground truth labels to facilitate training of a proposed deep neural network design. Detailed loss functions may be used to train map and actor decoders, with detailed separable attention mechanisms. In some examples, information may be pulled from the actor decoder to the map decoder for improved map inferences.

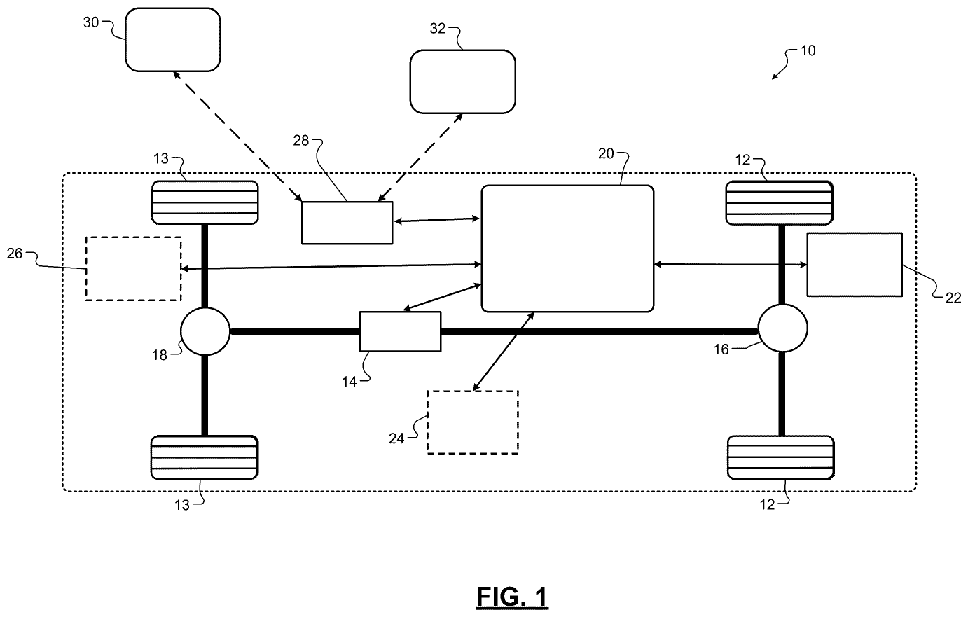

Referring now to FIG. 1, a vehicle 10 includes front wheels 12 and rear wheels 13. In FIG. 1, a drive unit 14 selectively outputs torque to the front wheels 12 and/or the rear wheels 13 via drive lines 16, 18, respectively. The vehicle 10 may include different types of drive units. For example, the vehicle may be an electric vehicle such as a battery electric vehicle (BEV), a hybrid vehicle, or a fuel cell vehicle, a vehicle including an internal combustion engine (ICE), or other type of vehicle.

Some examples of the drive unit 14 may include any suitable electric motor, a power inverter, and a motor controller configured to control power switches within the power inverter to adjust the motor speed and torque during propulsion and/or regeneration. A battery system provides power to or receives power from the electric motor of the drive unit 14 via the power inverter during propulsion or regeneration.

While the vehicle 10 includes one drive unit 14 in FIG. 1, the vehicle 10 may have other configurations. For example, two separate drive units may drive the front wheels 12 and the rear wheels 13, one or more individual drive units may drive individual wheels, etc. As can be appreciated, other vehicle configurations and/or drive units can be used.

The vehicle control module 20 may be configured to control operation of one or more vehicle components, such as the drive unit 14 (e.g., by commanding torque settings of an electric motor of the drive unit 14). The vehicle control module 20 may receive inputs for controlling components of the vehicle, such as signals received from a steering wheel, an acceleration pedal, a brake pedal, etc. The vehicle control module 20 may monitor telematics of the vehicle for safety purposes, such as vehicle speed, vehicle location, vehicle braking and acceleration, etc.

The vehicle control module 20 may receive signals from any suitable components for monitoring one or more aspects of the vehicle, including one or more vehicle sensors (such as cameras, microphones, pressure sensors, steering wheel position sensors, braking sensors, location sensors such as global positioning system (GPS) antennas, wheel height and/or position sensors, accelerometers, etc.). Some sensors may be configured to monitor current motion of the vehicle, acceleration of the vehicle, braking of the vehicle, current steering direction of the vehicle, current height and/or position of one or more wheels, etc.

In the example of FIG. 1, the vehicle 10 includes a front vehicle camera 22, an optional side vehicle camera 24, and an optional rear vehicle camera 26. Each camera may include any suitable camera hardware components, image processing capabilities, etc., to capture images of surroundings of the vehicle, such as road features, other vehicles, etc. In some examples, images from vehicle cameras may be used for object detection, automated driving, virtual lane determination at unmarked intersections, etc. Other example embodiments may include more or less cameras, or cameras at other positions on the vehicle 10. Other systems such as Lidar may be used to determine images or information about the surrounding environment of the vehicle.

The vehicle control module 20 may communicate with another device via a wireless communication interface 28, which may include one or more wireless antennas for transmitting and/or receiving wireless communication signals. For example, the wireless communication interface 28 may communicate via any suitable wireless communication protocols, including but not limited to vehicle-to-everything (V2X) communication, Wi-Fi communication, wireless area network (WAN) communication, cellular communication, personal area network (PAN) communication, short-range wireless communication (e.g., Bluetooth), etc. The wireless communication interface 28 may communicate with a remote computing device over one or more wireless and/or wired networks. Regarding the vehicle-to-vehicle (V2X) communication, the vehicle 10 may include one or more V2X transceivers (e.g., V2X signal transmission and/or reception antennas).

As shown in FIG. 1, the wireless communication interface 28 is configured to receive images from aerial imaging cameras 30. For example, one or more satellites may obtain images of an intersection, which are transmitted to the vehicle or stored in a vehicle memory (or on a server), to facilitate lane determination in an unmarked intersection.

Similarly, the wireless communication interface 28 may be configured to receive images from infrastructure mounted cameras 32. For example, cameras mounted on a streetlight of the intersection, a building adjacent the intersection, other road features near the intersection, etc., may be configured to capture images of the intersection which can be used by the vehicle control module 20 to determine virtual lane markings for the intersection.

The vehicle control module 20 may determine virtual lane markings for the intersection in real-time based on images from the vehicle cameras, using real-time or previously stored images from the infrastructure mounted cameras 32 or aerial imaging cameras 30. For example, as described further below, images from the aerial imaging cameras 30, the infrastructure mounted cameras 32 and the vehicle cameras may be supplied to one or more machine learning models to determine virtual lane markings at an intersection. The vehicle control module 20 may configured to use the predicted virtual lane markings of the intersection to automatically control acceleration of the vehicle 10 (e.g., via an accelerator or controlling a motor of the drive unit 14 to provide more power to the front wheels 12 and the rear wheels 13), to control braking of the vehicle 10 (e.g., via brakes applied to the front wheels 12 and the rear wheels 13 or via engine breaking at a motor of the drive unit 14), to control automated steering of the vehicle 10 (e.g., by rotating a steering mechanism or directly changing an orientation of the front wheels 12), etc.

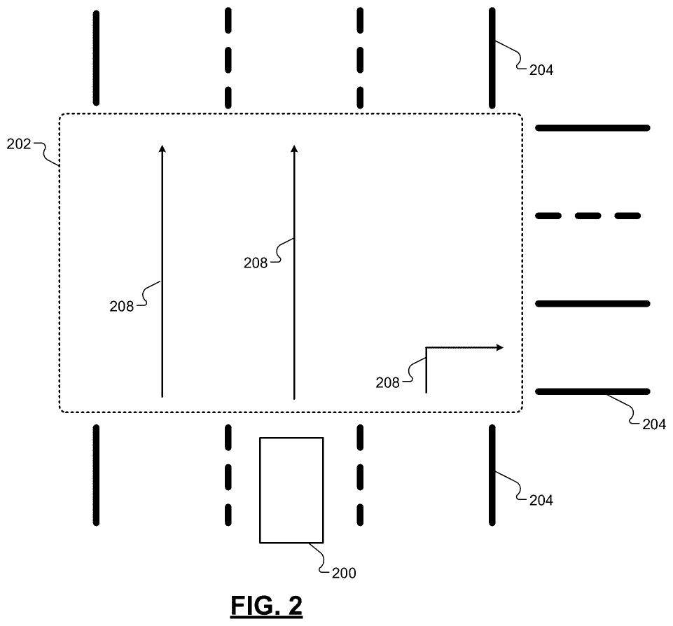

FIG. 2 is an example overhead view of a road intersection with unmarked lanes. As shown in FIG. 2, a host vehicle 200 is driving in a marked lane 204, approaching an intersection 202. The intersection 202 does not include lane markings (or includes only partial lane markings).

For example, the marked lane 204 may include lines painted on the road (e.g., in white or yellow), to mark the boundaries of the lane. The intersection 202 may not include any painted lane lines or other markings, or may include only some lane lines while other portions of the intersection 202 are absent of any lane markings.

As described further herein, a vehicle control module of the host vehicle 10 may determine virtual lanes 208 of the intersection 202, based on vehicle camera images, aerial images of the intersection 202, and infrastructure mounted camera images from cameras near the intersection 202. As shown in FIG. 2, the vehicle control module has determined that two virtual lanes proceed straight through the intersection 202, while a furthest right lane has a right turn virtual lane. As described herein, a virtual lane or virtual lane marking may refer to predicting lane lines or boundaries of a virtual lane, a center line of the virtual lane path, etc.

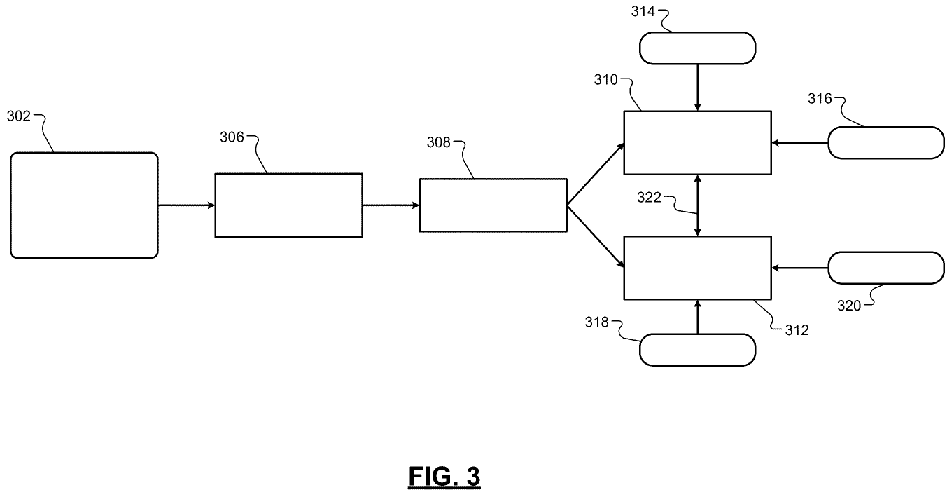

FIG. 3 is a block diagram of an example system for predicting virtual lanes in an intersection using aerial images and a transformer encoder. As shown in FIG. 3, aerial imagery (e.g., from one or more satellites capturing images of an intersection), may be supplied to a machine learning model, such as a convolutional neural network backbone 306.

An output of the convolutional neural network backbone 306 is provided to another machine learning model, such as a transformer encoder 308. An output of the transformer encoder 308 is then supplied to two different models, which include an auxiliary actor decoder 310 and a map decoder 312.

The auxiliary actor decoder 310 is configured to receive data from actor queries 314, and actor losses 316. The auxiliary actors may include other vehicles in or near the intersection, other vehicles traveling through the intersection, pedestrians walking on a sidewalk or cross walk of the intersection, etc.

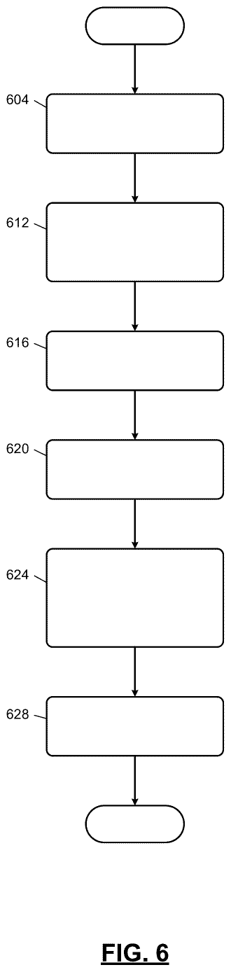

The auxiliary actor decoder 310 may be configured to generate a prediction output of virtual lanes of the intersection, based on the actor input. Additional details regarding the auxiliary actor decoder 310 are described further below with reference to FIG. 6.

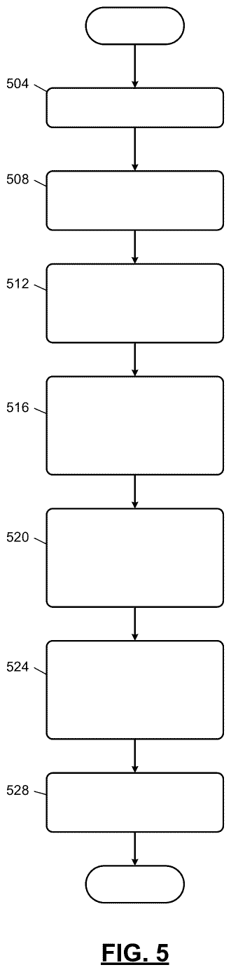

The map decoder 312 is configured to receive data from map queries 318, and map losses 320. The map input data may include features present in an overhead aerial view of the intersection. The map decoder 312 may be configured to generate a prediction output of virtual lanes of the intersection, based on the map input. Additional details regarding the map decoder 312 are described further below with reference to FIG. 5.

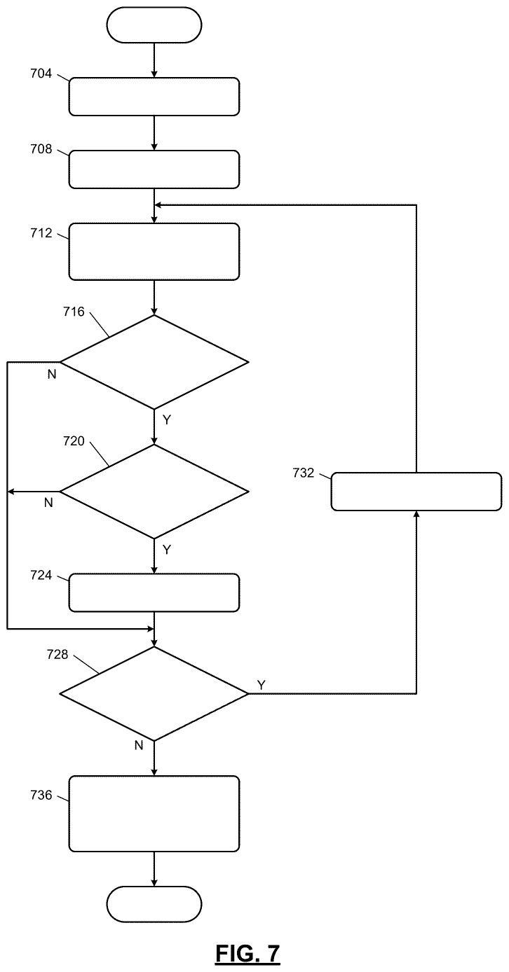

As shown in FIG. 3, the models may implement a relationship between the auxiliary actor decoder 310 and the map decoder 312, according to map-actor orientation interactions 322 (such as concatenating some actor features with the map features when the actor features meet a confidence threshold and/or distance threshold). Additional details regarding the map-actor orientation interactions 322 are described further below with reference to FIG. 7.

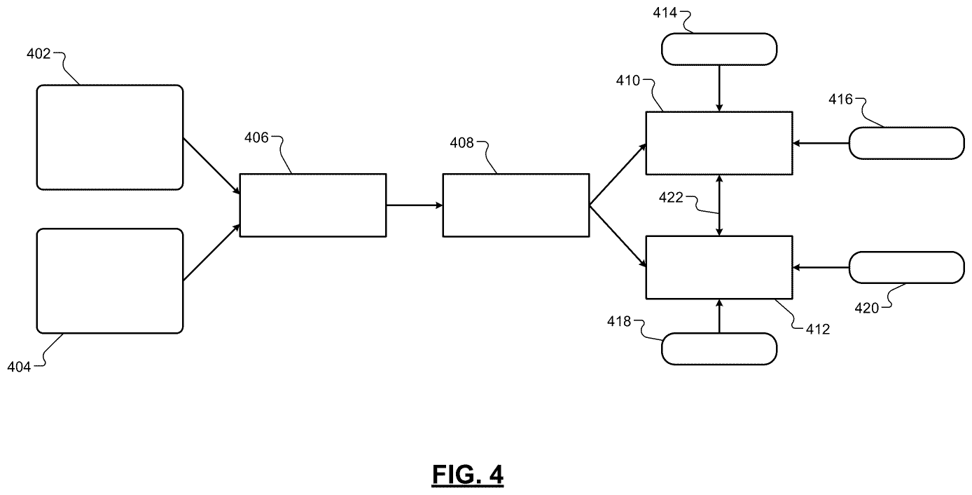

FIG. 4 is a block diagram of an example system for predicting virtual lanes in an intersection using infrastructure camera images and vehicle camera images, using a bird's-eye view former encoder. As shown in FIG. 4, infrastructure camera images (e.g., from one or more streetlights at the intersection, buildings near the intersection, road features adjacent the intersection, etc.), may be supplied to a machine learning model, such as a convolutional neural network backbone 406.

Vehicle camera images 404, such as images captured by the front vehicle camera 22 of the vehicle 10 in FIG. 1, the optional side camera 24 or the optional rear camera 26, may also be supplied to the convolutional neural network backbone 406.

An output of the convolutional neural network backbone 406 is provided to another machine learning model, such as a bird's-eye view encoder 408 (e.g., a BEVFormer). The bird's-eye view encoder 408 may be configured to covert the horizon perspective angle images of the infrastructure cameras and the vehicle cameras, into an overhead bird's eye view similar to the aerial images (which may be better suited for predicting lane lines of the intersection from a top down perspective). An output of the bird's-eye view encoder 408 is then supplied to two different models, which include an auxiliary actor decoder 410 and a map decoder 412.

The auxiliary actor decoder 410 is configured to receive data from actor queries 414, and actor losses 416. The auxiliary actors may include other vehicles in or near the intersection, other vehicles traveling through the intersection, pedestrians walking on a sidewalk or cross walk of the intersection, etc. The auxiliary actor decoder 410 may be configured to generate a prediction output of virtual lanes of the intersection, based on the actor input.

The map decoder 412 is configured to receive data from map queries 418, and map losses 420. The map input data may include features present in an overhead aerial view of the intersection. The map decoder 412 may be configured to generate a prediction output of virtual lanes of the intersection, based on the map input. As shown in FIG. 4, the models may implement a relationship between the auxiliary actor decoder 410 and the map decoder 412, according to map-actor orientation interactions 422 (such as concatenating some actor features with the map features when the actor features meet a confidence threshold and/or distance threshold).

FIG. 5 is a flowchart depicting an example process for predicting virtual lanes in an intersection using aerial images and a transformer encoder. The process may be performed by, for example, the vehicle control module 20 of FIG. 1. At 504, the process begins by obtaining input values for a present lane instance, such as a lane a host vehicle is currently traveling in.

At 508, the vehicle control module is configured to obtain average feature input values for all other lanes, such as lanes on a right side and left side of a lane the host vehicle is currently traveling in. The vehicle control module then supplies the input values to a transformer model at 512, which includes cross-attention and self-attention.

At 516, the vehicle control module is configured to output classifications for a present lane, a left lane, and a right lane. The output may include focal losses for lane type and edge type. The vehicle control module is configured to determine intersection over union (IoU) loss for bounding boxes of predicted lanes and ground truth labels, at 520.

At 524, the vehicle control module is configured to determine a cosine of an angle between a principal orientation of predicted lanes and ground truth labels. Control then determines predicted virtual lanes of the intersection at 528, based on the model output.

FIG. 6 is a flowchart depicting an example process for predicting virtual lanes in an intersection using infrastructure camera images and vehicle camera images, using a bird's-eye view former encoder. The process may be performed by, for example, the vehicle control module 20 of FIG. 1. At 604, the process begins by obtaining input values for actors in proximity to a present lane, such as other vehicles, pedestrians, etc. near a present lane of a host vehicle.

At 612, the vehicle control module is configured to supply the input values to a transformer model, which includes cross-attention and self-attention. At 616, the vehicle control module is configured to output classifications for actor types, which may include focal losses.

At 620, the vehicle control module is configured to determine losses for actor position and orientation regression. Control then determines a cosine of an angle between a principal orientation of predicted actor orientation and ground truth orientation labels, at 624. At 628, the vehicle control module is configured to determine predicted virtual lanes of the intersection based on the model output.

FIG. 7 is a flowchart depicting an example process for modifying inputs map input features of a map decoder based on corresponding actor features. The process may be performed by, for example, the vehicle control module 20 of FIG. 1. At 704, the process begins by obtaining map-based model features (such as input features corresponding to aerial images or geographic positions of features with respect to the intersection).

At 708, the vehicle control module is configured to obtain actor-based model features, such as features related to other vehicles, pedestrians at the intersection, etc. Control then selects a first actor feature from the list of actor features at 712, and compares the actor feature to a specified confidence score threshold.

If a confidence score of the selected actor feature is not above the specified confidence score threshold at 716, control proceeds to 728 to determine whether there are any additional actor features remaining in the list. If the confidence score is greater than the specified confidence score threshold at 716, control proceeds to 720 to compare a distance score of the actor feature to a specified distance score threshold.

If the distance score of the actor features is less than the distance score threshold at 720, control proceeds to 728 to determine whether there are any additional actor features remaining in the list. If the distance score is greater than the specified distance score threshold at 720, control proceeds to 724 to add the actor feature to the list of map features (such as by concatenating the actor feature to a list of inputs for processing by the map decoder).

If any actor features are remaining from the list at 728, control proceeds to 732 to select a next actor feature from the list. Once all actor features have been processed at 728, control proceeds to 736 to process the concatenated list (e.g., actor features added to the map feature inputs), using multilayer perceptron (MLP) networks and a feed-forward network.

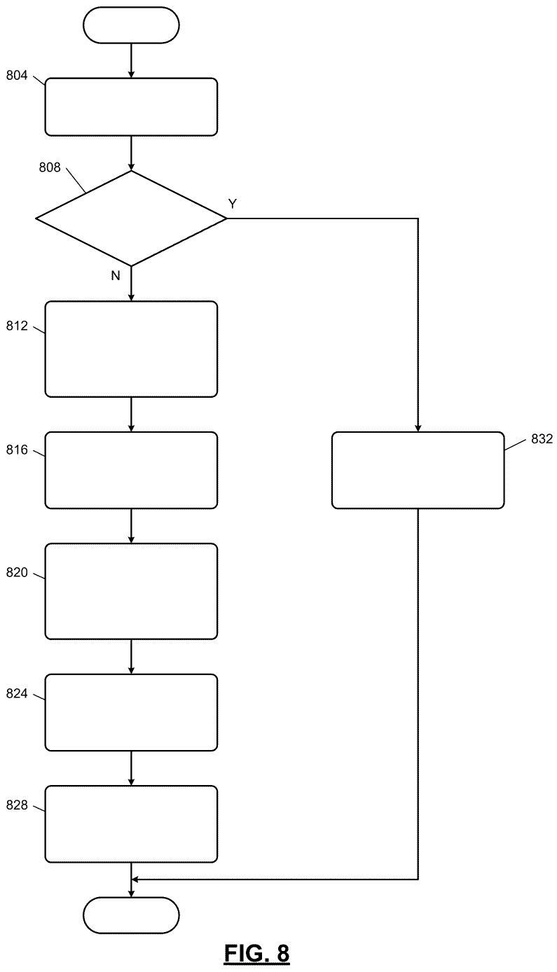

FIG. 8 is a flowchart depicting an example process of determining virtual lanes at unmarked intersections. The process may be performed by, for example, the vehicle control module 20 of FIG. 1. At 804, the process begins by obtaining a lane marking status for an upcoming intersection. For example, the vehicle control module may determine, based on stored map data and/or vehicle camera images, whether an upcoming intersection includes physical lane markings painted on the road surface in the intersection.

If the vehicle control module determines at 808 that the intersection lanes are marked on the road (e.g., fully marked with all lanes visible on the road surface), control proceeds to 832 to automatically control steering, braking and acceleration of the vehicle based on the marked lanes in the intersection. If the intersection is not fully marked at 808, control proceeds to 812 to obtain aerial images, infrastructure camera images, and vehicle camera images, of the intersection.

The vehicle control module may obtain one or more images of each type, which may be capture in real-time or obtained from previously stored images. At 816, the vehicle control module is configured to supply the aerial images to a transformer encoder to generate a prediction output.

At 820, the vehicle control module is configured to supply infrastructure and vehicle images to a bird's-eye view encoder (e.g., BEVFormer), to generate a prediction output. Control then determines virtual intersection lanes based on model prediction outputs at 824. At 828, the vehicle control module is configured to automatically control steering, acceleration and braking of the vehicle based on the determined or predicted virtual lane lines in the intersection.

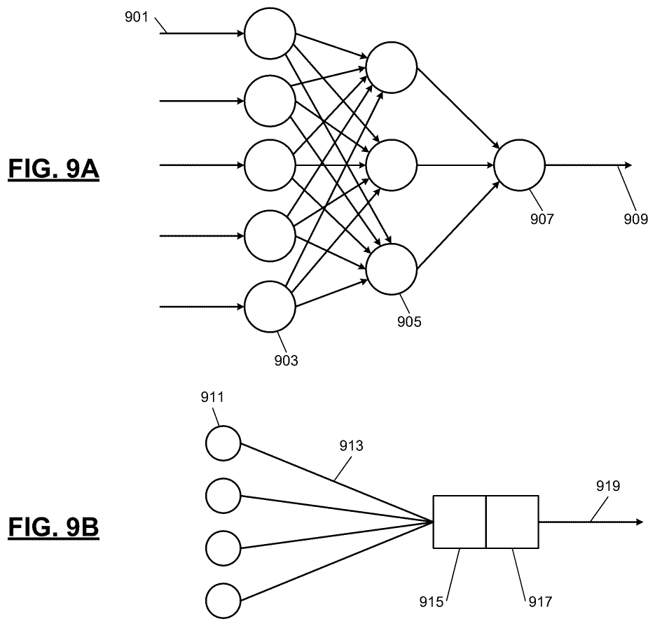

FIGS. 9A and 9B show an example of a recurrent neural network used to generate models such as those described above, using machine learning techniques. Machine learning is a method used to devise complex models and algorithms that lend themselves to prediction (for example, patient and provider matching predictions). The models generated using machine learning, such as those described above, can produce reliable, repeatable decisions and results, and uncover hidden insights through learning from historical relationships and trends in the data.

The purpose of using the recurrent neural-network-based model, and training the model using machine learning as described above, may be to directly predict dependent variables without casting relationships between the variables into mathematical form. The neural network model includes a large number of virtual neurons operating in parallel and arranged in layers. The first layer is the input layer 903 and receives raw input data 901. Each successive layer modifies outputs from a preceding layer and sends them to a next layer. The last layer is the output layer 907 and produces output 909 of the system.

FIG. 9A shows a fully connected neural network, where each neuron in a given layer is connected to each neuron in a next layer. In the input layer, each input node is associated with a numerical value, which can be any real number. In each layer, each connection that departs from an input node has a weight associated with it, which can also be any real number (see FIG. 9B). In the input layer, the number of neurons equals the number of features (columns) in a dataset. The output layer may have multiple continuous outputs.

The layers between the input layers 903 and output layers 907 are hidden layers 905. The number of hidden layers can be one or more (one hidden layer may be sufficient for most applications). A neural network with no hidden layers can represent linear separable functions or decisions. A neural network with one hidden layer can perform continuous mapping from one finite space to another. A neural network with two hidden layers can approximate any smooth mapping to any accuracy.

The number of neurons can be optimized. At the beginning of training, a network configuration is more likely to have excess nodes. Some of the nodes may be removed from the network during training that would not noticeably affect network performance. For example, nodes with weights approaching zero after training can be removed (this process is called pruning). The number of neurons can cause under-fitting (inability to adequately capture signals in dataset) or over-fitting (insufficient information to train all neurons; network performs well on training dataset but not on test dataset).

Various methods and criteria can be used to measure the performance of a neural network model. For example, root mean squared error (RMSE) measures the average distance between observed values and model predictions. Coefficient of Determination (R2) measures correlation (not accuracy) between observed and predicted outcomes. This method may not be reliable if the data has a large variance. Other performance measures include irreducible noise, model bias, and model variance. A high model bias for a model indicates that the model is not able to capture true relationship between predictors and the outcome. Model variance may indicate whether a model is stable (a slight perturbation in the data will significantly change the model fit). The neural network can receive inputs, e.g., vectors, which can be used to generate models that can be used for predicting virtual lanes in unmarked intersections, based on aerial images, infrastructure camera images, and vehicle images.

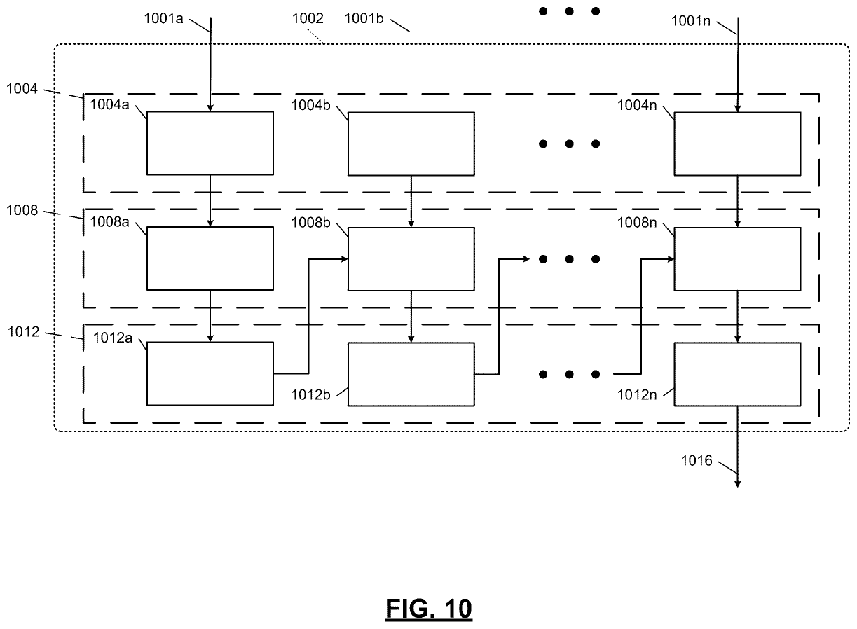

FIG. 10 illustrates an example of a long short-term memory (LSTM) neural network 1002. The LSTM neural network is one example of a machine learning model, and various example implementations may use other machine learning models such as a combination of transformers and multilayer perceptron (MLP) set prediction (e.g., MapTR) in the decoding process. For example, while LSTM may be utilized to output polylines that model inferred virtual lanes within intersections, other model types may be utilized to output desired virtual lanes such as, e.g., a combination of transformers and MLP set prediction to decode the encoded virtual lane queries into a vector of x, y coordinates.

The generic example LSTM neural network 1002 may be used to implement a machine learning model, and various implementations may use other types of machine learning networks (such as transformer layers, MLP set projections like MapTR, other model topologies or architectures, etc.). The LSTM neural network 1002 includes an input layer 1004, a hidden layer 1008, and an output layer 1012. The input layer 1004 includes inputs 1004a, 1004b . . . 1004n, which may correspond to input data 1001a, 1001a . . . 1001n. The hidden layer 1008 includes neurons 1008a, 1008b . . . 1008n. The output layer 1012 includes outputs 1012a, 1012b . . . 1012n.

Each neuron of the hidden layer 1008 receives an input from the input layer 1004 and outputs a value to the corresponding output in the output layer 1012. For example, the neuron 1008a receives an input from the input 1004a and outputs a value to the output 1012a. Each neuron, other than the neuron 1008a, also receives an output of a previous neuron as an input. For example, the neuron 1008b receives inputs from the input 1004b and the output 1012a. In this way the output of each neuron is fed forward to the next neuron in the hidden layer 1008. The last output 1012n in the output layer 1012 outputs a probability 1016 associated with the inputs 1004a-1004n. Although the input layer 1004, the hidden layer 1008, and the output layer 1012 are depicted as each including three elements, each layer may contain any number of elements.

In various implementations, each layer of the LSTM neural network 1002 must include the same number of elements as each of the other layers of the LSTM neural network 1002. In some example embodiments, a convolutional neural network may be implemented. Similar to LSTM neural networks, convolutional neural networks include an input layer, a hidden layer, and an output layer. However, in a convolutional neural network, the output layer includes one less output than the number of neurons in the hidden layer and each neuron is connected to each output. Additionally, each input in the input layer is connected to each neuron in the hidden layer. In other words, input 1004a is connected to each of neurons 1008a, 1008b . . . 1008n.

In various implementations, each input node in the input layer may be associated with a numerical value, which can be any real number. In each layer, each connection that departs from an input node has a weight associated with it, which can also be any real number. In the input layer, the number of neurons equals number of features (columns) in a dataset. The output layer may have multiple continuous outputs.

As mentioned above, the layers between the input and output layers are hidden layers. The number of hidden layers can be one or more (one hidden layer may be sufficient for many applications). A neural network with no hidden layers can represent linear separable functions or decisions. A neural network with one hidden layer can perform continuous mapping from one finite space to another. A neural network with two hidden layers can approximate any smooth mapping to any accuracy. The neural network of FIG. 10 can receive inputs, e.g., vectors, which can be used to generate models that can be used, for example, to predict virtual lanes in unmarked intersections, based on aerial images, infrastructure camera images, and vehicle images.

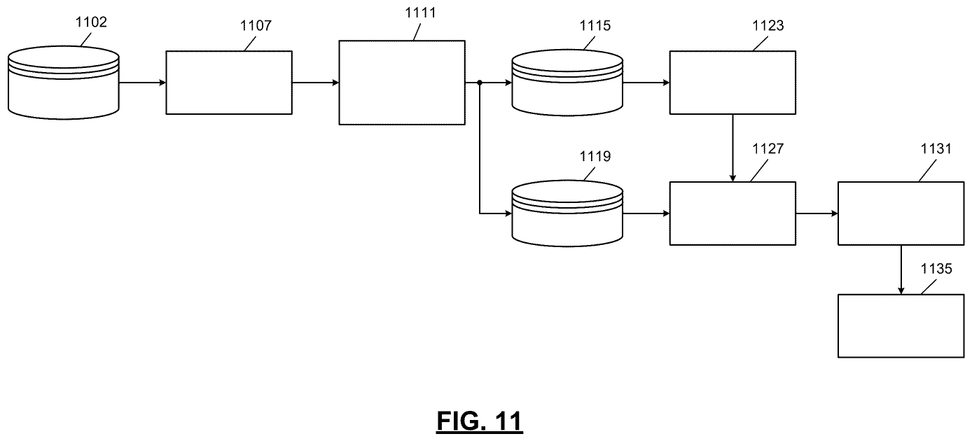

FIG. 11 illustrates an example process for generating a machine learning model. At 1107, control obtains data from a database 1102 (e.g., a data warehouse). The data may include any suitable data for developing machine learning models.

At 1111, control separates the data obtained from the database 1102 into training data 1115 and test data 1119. The training data 1115 is used to train the model at 1123, and the test data 1119 is used to test the model at 1127. Typically, the set of training data 1115 is selected to be larger than the set of test data 1119, depending on the desired model development parameters. For example, the training data 1115 may include about seventy percent of the data acquired from the database 1102, about eighty percent of the data, about ninety percent, etc. The remaining thirty percent, twenty percent, or ten percent, is then used as the test data 1119.

Separating a portion of the acquired data as test data 1119 allows for testing of the trained model against actual output data, to facilitate more accurate training and development of the model at 1123 and 1127. The model may be trained at 1123 using any suitable machine learning model techniques, including those described herein, such as random forest, generalized linear models, decision tree, and neural networks.

At 1131, control evaluates the model test results. For example, the trained model may be tested at 1127 using the test data 1119, and the results of the output data from the tested model may be compared to actual outputs of the test data 1119, to determine a level of accuracy. The model results may be evaluated using any suitable machine learning model analysis, such as the example techniques described further below.

After evaluating the model test results at 1131, the model may be deployed at 1135 if the model test results are satisfactory. Deploying the model may include using the model to make predictions for a large-scale input dataset with unknown outputs. If the evaluation of the model test results at 1131 is unsatisfactory, the model may be developed further using different parameters, using different modeling techniques, using other model types, etc. The machine learning model method of FIG. 11 can receive inputs, e.g., vectors, which can be used to generate models that can be used, for example, to predict virtual lanes in unmarked intersections, based on aerial images, infrastructure camera images, and vehicle images.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A vehicle autonomous driving control system comprising:
at least one satellite configured to obtain one or more aerial images of an intersection, wherein the intersection includes at least one unmarked lane;
an infrastructure mounted camera configured to obtain one or more infrastructure camera images of the intersection, wherein the infrastructure mounted camera is oriented with a viewing angle in a direction of the intersection;
a front vehicle camera configured to capture images from a front field of view of a vehicle;
a wireless interface of the vehicle, wherein the wireless interface is configured to wirelessly receive the one or more aerial images and the one or more infrastructure camera images; and
a vehicle control module configured to:
access the one or more aerial images and the one or more infrastructure camera images;
obtain one or more vehicle camera images from the front vehicle camera;
supply the one or more aerial images, the one or more infrastructure camera images, and the one or more vehicle camera images, to at least one machine learning model;
generate a virtual lane prediction according to an output of the at least one machine learning model, the virtual lane prediction indicative of one or more unmarked lanes present in the intersection; and
automatically control steering, acceleration and braking of the vehicle in the intersection according to the virtual lane prediction.

2. The vehicle autonomous driving control system of claim 1, wherein supplying the one or more aerial images includes supplying the one or more aerial images to a transformer encoder machine learning model.

3. The vehicle autonomous driving control system of claim 2, wherein supplying includes supplying the one or more infrastructure camera images and the one or more vehicle camera images to a bird's eye view (BEV) encoder machine learning model.

4. The vehicle autonomous driving control system of claim 2, wherein the vehicle control module is configured to:
supply an output of the transformer encoder machine learning model as an input to a map decoder machine learning model;
supply map query data and map loss data as inputs to the map decoder machine learning model; and
generate the virtual lane prediction at least in part based on an output of the map decoder machine learning model.

5. The vehicle autonomous driving control system of claim 4, wherein the vehicle control module is configured to:
supply an output of the transformer encoder machine learning model as an input to an auxiliary actor decoder machine learning model;
supply actor query data and actor loss data as inputs to the auxiliary actor decoder machine learning model; and
generate the virtual lane prediction at least in part based on an output of the auxiliary actor decoder machine learning model.

6. The vehicle autonomous driving control system of claim 5, wherein the vehicle control module is configured to concatenate a subset of actor features of the auxiliary actor decoder machine learning model to a list of map feature inputs of the map decoder machine learning model.

7. The vehicle autonomous driving control system of claim 1, wherein the vehicle control module is configured to:
supply the one or more aerial images to a convolutional neural network; and
supply an output of the convolutional neural network to a transformer encoder machine learning model.

8. The vehicle autonomous driving control system of claim 1, wherein automatically controlling steering, acceleration and braking of the vehicle includes controlling operation of the vehicle via map-free autonomous driving.

9. The vehicle autonomous driving control system of claim 1, wherein the vehicle control module is configured to:
obtain the one or more vehicle camera images from the front vehicle camera in real-time in response to the vehicle approaching the intersection; and
access the one or more aerial images and the one or more infrastructure camera images from a stored memory, wherein the access the one or more aerial images and the one or more infrastructure camera images are previously stored images.

10. The vehicle autonomous driving control system of claim 4, wherein the vehicle control module is configured to determine an intersection over union (IoU) loss for bounding boxes of predicted lanes and ground truth labels, for the map decoder machine learning model.

11. The vehicle autonomous driving control system of claim 5, wherein the vehicle control module is configured to determine a cosine of an angle between principal orientations of predicted actor orientations and ground truth orientation labels, for the auxiliary actor decoder machine learning model.

12. A method of vehicle autonomous driving control, the method comprising:
obtaining, via a wireless interface of a vehicle, one or more aerial images of an intersection, wherein the intersection includes at least one unmarked lane, and the one or more aerial images are captured by at least one satellite;
obtaining, via the wireless interface of the vehicle, one or more infrastructure camera images of the intersection from an infrastructure mounted camera, wherein the infrastructure mounted camera is oriented with a viewing angle in a direction of the intersection;
receiving one or more vehicle camera images from a front vehicle camera of the vehicle;
supplying the one or more aerial images, the one or more infrastructure camera images, and the one or more vehicle camera images, to at least one machine learning model;
generating a virtual lane prediction according to an output of the at least one machine learning model, the virtual lane prediction indicative of one or more unmarked lanes present in the intersection; and
automatically controlling steering, acceleration and braking of the vehicle in the intersection according to the virtual lane prediction.

13. The method of claim 12, wherein supplying the one or more aerial images includes supplying the one or more aerial images to a transformer encoder machine learning model.

14. The method of claim 13, wherein supplying includes supplying the one or more infrastructure camera images and the one or more vehicle camera images to a bird's eye view (BEV) encoder machine learning model.

15. The method of claim 13, wherein further comprising:
supplying an output of the transformer encoder machine learning model as an input to a map decoder machine learning model;
supplying map query data and map loss data as inputs to the map decoder machine learning model; and
generating the virtual lane prediction at least in part based on an output of the map decoder machine learning model.

16. The method of claim 15, further comprising:
supplying an output of the transformer encoder machine learning model as an input to an auxiliary actor decoder machine learning model;
supplying actor query data and actor loss data as inputs to the auxiliary actor decoder machine learning model; and
generating the virtual lane prediction at least in part based on an output of the auxiliary actor decoder machine learning model.

17. The method of claim 16, further comprising concatenating a subset of actor features of the auxiliary actor decoder machine learning model to a list of map feature inputs of the map decoder machine learning model.

18. The method of claim 12, further comprising:
supplying the one or more aerial images to a convolutional neural network; and
supplying an output of the convolutional neural network to a transformer encoder machine learning model.

19. The method of claim 12, wherein automatically controlling steering, acceleration and braking of the vehicle includes controlling operation of the vehicle via map-free autonomous driving.

20. A vehicle autonomous driving control system comprising:
a front vehicle camera configured to capture images from a front field of view of a vehicle;
a wireless interface configured to:
wirelessly receive one or more aerial images of an intersection, wherein the intersection includes at least one unmarked lane, and the one or more aerial images are captured by at least one satellite; and
wireless receive one or more infrastructure camera images of the intersection from an infrastructure mounted camera, wherein the infrastructure mounted camera is oriented with a viewing angle in a direction of the intersection; and
a vehicle control module configured to:
access the one or more aerial images and the one or more infrastructure camera images;
obtain one or more vehicle camera images from the front vehicle camera;
supply the one or more aerial images, the one or more infrastructure camera images, and the one or more vehicle camera images, to at least one machine learning model;
generate a virtual lane prediction according to an output of the at least one machine learning model, the virtual lane prediction indicative of one or more unmarked lanes present in the intersection; and
automatically control steering, acceleration and braking of the vehicle in the intersection according to the virtual lane prediction.
